(19) United States
(12) Patent Application Publication
(10) Pub. No.: US 2020/0174327 A1
(43) Pub. Date: Jun. 4, 2020

(54) LIQUID CRYSTAL DISPLAY PANEL WITH ULTRA-NARROW BOTTOM BORDER AND MANUFACTURING METHOD THEREOF

(71) Applicant: Wuhan China Star Optoelectronics Technology Co., Ltd., Wuhan, Hubei (CN)

(72) Inventor: Wenqing SONG, Wuhan, Hubei (CN)

(73) Assignee: Wuhan China Star Optoelectronics Technology Co., Ltd., Wuhan, Hubei (CN)

(21) Appl. No.: 15/743,700

(22) PCT Filed: Dec. 18, 2017
(86) PCT No.: PCT/CN2017/116839

§ 371 Date: Jan. 11, 2018

(30) Foreign Application Priority Data
Aug. 28, 2017 (CN) 201710751712.0

(51) Int. Cl. G02F 1/1362

(52) U.S. Cl. CPC G02F 1/136227

(57) ABSTRACT

The embodiments of the disclosure provide a liquid crystal display panel with ultra-narrow bottom border, including: a TFT array substrate, a CF substrate, and a liquid crystal layer disposed between the TFT array substrate and the CF substrate, the TFT array substrate comprises a substrate, the substrate includes an active display area located at the middle and a peripheral area located outside the active display area, at least a portion of a bottom border area of the peripheral area extends out of the CF substrate, the bottom border area is etched to form a pattern, an insulating layer is disposed thereon, an upper side of the insulating layer is etched to form a plurality of LCD conductive pads, a plurality of through holes are formed on the insulating layer, and each of the LCD conductive pads electrically connects to the TFT array lead via one of the through holes.

### RELATED APPLICATIONS

The present application is a National Phase of International Application Number PCT/CN2017/116839, filed Dec. 18, 2017, and claims the priority of China Application No. 201710751712.0, filed Aug. 28, 2017.

### FIELD OF THE DISCLOSURE

The disclosure relates to the technical field of display device, and particularly to a liquid crystal display panel with ultra-narrow bottom border and a method thereof.

### BACKGROUND

The liquid crystal display panel includes an active area and a peripheral circuit area. A plurality of pixels is disposed in the active area to form a pixel array, a peripheral circuit is disposed in the peripheral circuit area. Each pixel includes a thin film transistor and a pixel electrode connected to the thin film transistor, and each pixel is surrounded by two adjacent scan lines and two adjacent data lines. Usually, the scan lines and the data lines will extend from the active area to the peripheral circuit area, and electrically connect to a drive chip via the peripheral circuit.

In general, the driver chip is with a specific size design, the peripheral circuit gathers up from an end connected to the scan lines and the data lines to an area the driver chip located.

As shown in FIG. 1, a schematic plan view of a conventional liquid crystal display panel is shown, the liquid crystal display panel includes a TFT array substrate 2′, a CF substrate 1′ disposed opposite to the TFT array substrate 2′, and a liquid crystal layer (not shown) disposed between the TFT array substrate 2′ and the CF substrate 1′, a glass substrate of the TFT array substrate 2′ includes an active display area 20′ located at the middle and a peripheral area 21′ located outside the active display area 20′, wherein the CF substrate in a bottom border area 21′ of the peripheral area 21′ is cut off, and the glass substrate in this area is etched to form a pattern, in general, a width of the bottom border is S (such as 5 mm), the needs to be achieved such as the trace from the data lines to the IC, IC bonding pattern pads, lighting pattern pads and two-dimensional code and so on.

Please further refer to FIG. 2 to FIG. 5, FIG. 2 is a schematic view of the right side of FIG. 1, as shown in FIG. 2, a LCD conductive pad 24′ is formed by etching a bottom border area of the glass substrate of the TFT array substrate 2′; please further combine with FIG. 3 to FIG. 5, in the conventional LCD structure, the LCD conductive pad overlaps and aligns a data pad on the driver IC to transmit signal from the driver IC to the glass.

In summary, many design components need to be arranged on the glass substrate of the TFT array substrate 2′. In this structure, the width of the bottom border is longer and difficult to reduce.

### SUMMARY

A technical problem to be solved by the disclosure is to provide a liquid crystal display panel with ultra-narrow bottom border and a method thereof, so the ultra-narrow bottom border could be achieved.

To achieve the above object, according to one aspect, the embodiment of the disclosure provides a liquid crystal display panel with ultra-narrow bottom border, including:

a TFT array substrate;

a CF substrate, disposed opposite to the TFT array substrate; and

a liquid crystal layer, disposed between the TFT array substrate and the CF substrate;

wherein the TFT array substrate comprises a substrate, the substrate includes an active display area located at the middle and a peripheral area located outside the active display area;

wherein at least a portion of a bottom border area of the peripheral area extends out of the CF substrate, the bottom border area is etched to form a TFT array lead, an insulating layer is disposed on the TFT array lead, and an upper side of the insulating layer is etched to form a plurality of LCD conductive pads;

wherein a plurality of through holes is formed on the insulating layer, each of the LCD conductive pads electrically connects to the TFT array lead via one of the through holes.

In one embodiment, wherein the insulating layer is a photoresist layer or an organic insulating layer.

In one embodiment, wherein a material of the LCD conductive pads is ITO, an ITO film is formed in each of the through holes, and each of the LCD conductive pads electrically connects to the TFT array lead via the ITO film of one of the through holes.

According to another aspect, the embodiment of the disclosure provides a manufacturing method of a liquid crystal display panel with ultra-narrow bottom border, including the following steps:

cutting an entire produced substrate to form a plurality of LCD panel, each of the LCD panel comprising a TFT array substrate, a CF substrate disposed opposite to the TFT array substrate, and a liquid crystal layer disposed between the TFT array substrate and the CF substrate;

cutting the CF substrate of a bottom border area of each of the LCD panel to expose a pattern on a substrate of the TFT array substrate in the bottom border area;

forming an insulating layer on the substrate of the TFT array substrate exposed in the bottom border area, etching the insulating layer to form a plurality of LCD conductive pads configured to electrically connect a connection point of a driver chip, and on the insulating layer, wherein, each of the LCD conductive pads electrically connects to a TFT array lead formed by etching a bottom border area of the substrate of the TFT array substrate via one of a plurality of through holes.

In one embodiment, wherein the insulating layer is a photoresist layer or an organic insulating layer.

In one embodiment, wherein the manufacturing method of a liquid crystal display panel with ultra-narrow bottom border further includes:

forming an ITO film in each of the through holes, wherein a first LCD conductive pad of an upper side of the insulating layer electrically connects to the TFT array lead via the ITO film of one of the through holes.

The beneficial effects of the disclosure are as follows, in the embodiments of the disclosure, by disposing the insulating layer (photoresist or organic insulating layer) on the substrate of the TFT array substrate in the bottom border area of the liquid crystal display panel, then etching the insulating layer to form the LCD conductive pad and disposing a through hole on the insulating layer makes the LCD conductive pad on the insulating layer electrically connect to the TFT array lead of the substrate of the TFT array substrate, so a portion of the pattern on the substrate could transfer to the insulating layer to reduce the length of the bottom border.

In addition, the structure and the circuit connection of the embodiments of the disclosure are easy to implement and very adaptable.

### BRIEF DESCRIPTION OF THE DRAWINGS

Accompanying drawings are for providing further understanding of embodiments of the disclosure. The drawings form a part of the disclosure and are for illustrating the principle of the embodiments of the disclosure along with the literal description. Apparently, the drawings in the description below are merely some embodiments of the disclosure, a person skilled in the art can obtain other drawings according to these drawings without creative efforts.

FIG. 1 is a schematic plan view of a conventional liquid crystal display panel;

FIG. 2 is a schematic view of the right side of FIG. 1;

FIG. 3 is a schematic plan view of the LCD conductive pad of FIG. 1;

FIG. 4 is a schematic plan view of the connection point of the driver chip of FIG. 1;

FIG. 5 is a structural schematic view of the LCD conductive pad overlapping the conductive pad of the driver chip of FIG. 1;

FIG. 6 is a schematic plan view of a liquid crystal display panel with ultra-narrow bottom border according to an embodiment of the disclosure;

FIG. 7 is a schematic view of the right side of FIG. 6;

FIG. 8 is a longitudinal section connection schematic view of the insulating layer of FIG. 7;

FIG. 9 is an electrical connection schematic view of the insulating layer of FIG. 7;

FIG. 10 is a main flow chart diagram of a manufacturing method of a liquid crystal display panel with ultra-narrow bottom border according to an embodiment of the disclosure.

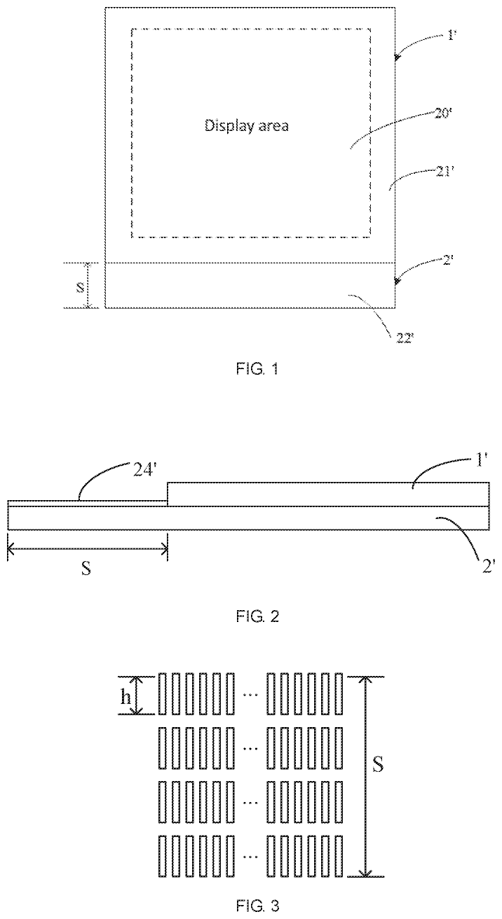

### DETAILED DESCRIPTION OF PREFERRED EMBODIMENTS

In order to illustrate a technical solution according to embodiments of the disclosure more clearly, drawings to be used in the description of the embodiments will be briefly set forth in the following. It is obvious that the drawings in the following description are only related to some embodiments of the disclosure. Those ordinarily skilled in the art may obtain other embodiments according to these drawings, without any inventive work.

In the following description of the disclosure, exemplary embodiments are described in conjunction with the accompanying drawings. For clarity and simplicity, not all the features of actual implementations are described in the description.

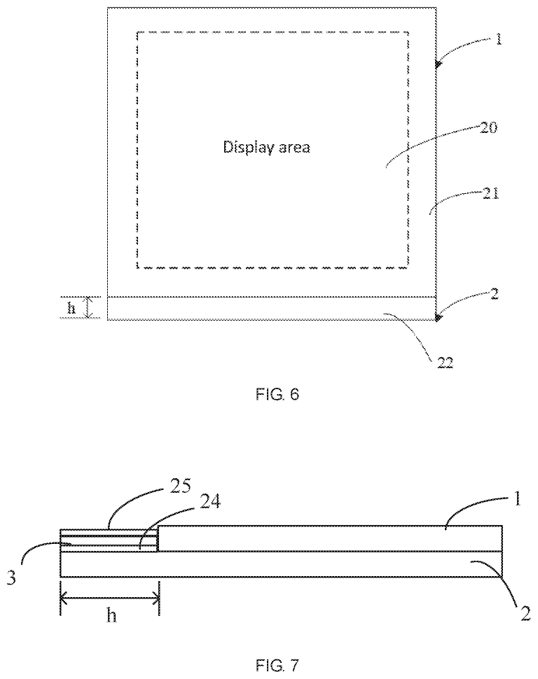

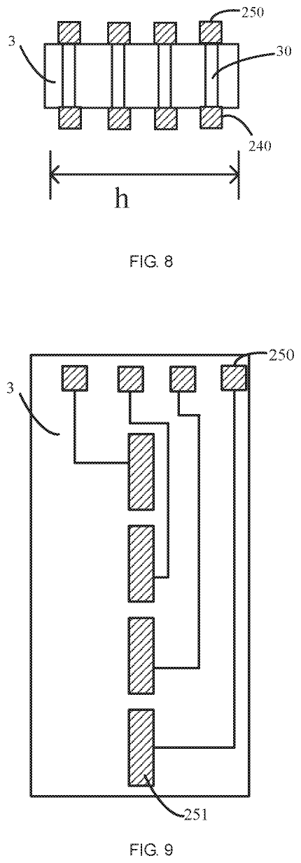

As shown in FIG. 6, FIG. 6 is a schematic plan view of a liquid crystal display panel with ultra-narrow bottom border according to an embodiment of the disclosure, please also refer to FIG. 7 to FIG. 9 together, in this embodiment, the liquid crystal display panel with ultra-narrow bottom border includes a TFT array substrate 2, a CF substrate 1 disposed opposite to the TFT array substrate 2, and a liquid crystal layer, (not shown) disposed between the TFT array substrate 2 and the CF substrate 1, the TFT array substrate 2 includes a substrate, in one embodiment, the substrate may be a glass substrate, the substrate includes an active display area 20 located at the middle and a peripheral area 21 located outside the active display area 20.

Wherein, at least a portion of a bottom border area 22 of the peripheral area 21 extends out of the CF substrate 1, the bottom border area 22 is etched to form a pattern 24, the pattern may be an ITO pattern to achieve the TFT array lead function such as the lead of the data lines and the scan lines and so on, an insulating layer 3 is disposed on the pattern 24, and an upper side of the insulating layer 3 is etched to form a LCD conductive pad layer 25, a plurality of LCD conductive pads 250 are formed thereon and configured to electrically connect to the connection point of the driver chip (not shown), specifically, as shown in FIG. 9, in one embodiment, on the insulating layer 3, the LCD conductive pads 250 could further use the extending trace to electrically connect to the connection point of the driver chip via auxiliary conductive pads 251; it should be understood that the LCD conductive pads 250 and the auxiliary conductive pads 251 may include ITO; in addition, a plurality of through holes 30 are formed on the insulating layer 3, each of the LCD conductive pads 250 of the upper side of the insulating layer 3 electrically connects to the TFT array lead formed by etching the bottom border area 22 of the substrate of the TFT array substrate 2 via one of the through holes 30. An ITO film (not shown) is formed in each of the through holes 30, and each of the LCD conductive pads 250 electrically connects to the TFT array lead 240 formed by etching the bottom border area 22 of the substrate of the TFT array substrate 2 via the ITO film of one of the through holes 30.

It should be understood that the insulating layer may be a photoresist layer or an organic insulating layer.

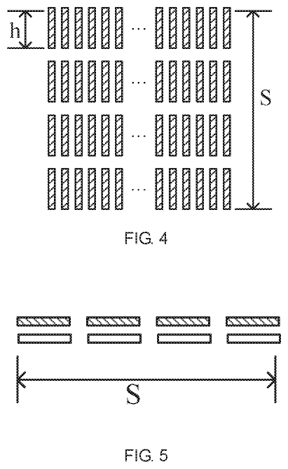

It should be understood that through the structures shown in FIG. 5 to FIG. 6, the length of the bottom border of the liquid crystal display panel can be reduced to h (equal to the length of one pad in the prior art, for example, may be about 1 mm), wherein h may be less than a quarter of the length S of the bottom border in the prior art.

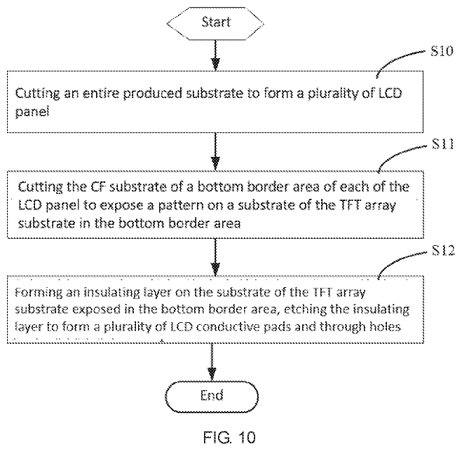

Correspondingly, the embodiment of the disclosure further provides a manufacturing method of a liquid crystal display panel with ultra-narrow bottom border, as shown in FIG. 10, in this embodiment, the manufacturing method includes the following steps:

Step S10, cutting an entire produced substrate to form a plurality of LCD panel, each of the LCD panel comprising a TFT array substrate, a CF substrate disposed opposite to the TFT array substrate, and a liquid crystal layer disposed between the TFT array substrate and the CF substrate;

Step S11, cutting the CF substrate of a bottom border area of each of the LCD panel to expose a pattern on a substrate of the TFT array substrate in the bottom border area;

Step S12, forming an insulating layer on the substrate of the TFT array substrate exposed in the bottom border area, etching the insulating layer to form a plurality of LCD conductive pads configured to electrically connect a connection point of a driver chip, and on the insulating layer, wherein, each of the LCD conductive pads electrically connects to a TFT array lead formed by etching a bottom border area of the substrate of the TFT array substrate via one of a plurality of through holes.

Wherein, the insulating layer is a photoresist layer or an organic insulating layer.

Wherein, the manufacturing method further includes: forming an ITO film in each of the through holes, wherein a first LCD conductive pad of an upper side of the insulating layer electrically connects to the TFT array lead via the ITO film of one of the through holes.

The beneficial effects of the disclosure are as follows, in the embodiments of the disclosure, by disposing the insulating layer (photoresist or organic insulating layer) on the substrate of the TFT array substrate in the bottom border area of the liquid crystal display panel, then etching the insulating layer to form the LCD conductive pad and disposing a through hole on the insulating layer makes the LCD conductive pad on the insulating layer electrically connect to the TFT array lead of the substrate of the TFT array substrate, so a portion of the pattern on the substrate could transfer to the insulating layer to reduce the length of the bottom border.

In addition, the structure and the circuit connection of the embodiments of the disclosure are easy to implement and very adaptable.

It should be noted that the relational terms herein, such as “first” and “second”, are used only for differentiating one entity or operation, from another entity or operation, which, however do not necessarily require or imply that there should be any real relationship or sequence. Moreover, the terms “comprise”, “include” or any other variations thereof are meant to cover non-exclusive including, so that the process, method, article or device comprising a series of elements do not only comprise those elements, but also comprise other elements that are not explicitly listed or also comprise the inherent elements of the process, method, article or device. In the case that there are no more restrictions, an element qualified by the statement “comprises a . . . ” does not exclude the presence of additional identical elements in the process, method, article or device that comprises the said element.

The foregoing contents are detailed description of the disclosure in conjunction with specific preferred embodiments and concrete embodiments of the disclosure are not limited to this description. For the person skilled in the art of the disclosure, without departing from the concept of the disclosure, simple deductions or substitutions can be made and should be included in the protection scope of the application.

What is claimed is:

1. A liquid crystal display panel with ultra-narrow bottom border, comprising:
a TFT array substrate;
a CF substrate, disposed opposite to the TFT array substrate; and
a liquid crystal layer, disposed between the TFT array substrate and the CF substrate;
wherein the TFT array substrate comprises a substrate, the substrate includes an active display area located at the middle and a peripheral area located outside the active display area;
wherein at least a portion of a bottom border area of the peripheral area extends out of the CF substrate, the bottom border area is etched to form a TFT array lead, an insulating layer is disposed on the TFT array lead, and an upper side of the insulating layer is etched to form a plurality of LCD conductive pads;
wherein a plurality of through holes are formed on the insulating layer, each of the LCD conductive pads electrically connects to the TFT array lead via one of the through holes.

2. The liquid crystal display panel with ultra-narrow bottom border according to claim 1, wherein the insulating layer is a photoresist layer or an organic insulating layer.

3. The liquid crystal display panel with ultra-narrow bottom border according to claim 1, wherein a material of the LCD conductive pads is ITO, an ITO film is formed in each of the through holes, and each of the LCD conductive pads electrically connects to the TFT array lead via the ITO film of one of the through holes.

4. The liquid crystal display panel with ultra-narrow bottom border according to claim 2, wherein a material of the LCD conductive pads is ITO, an ITO film is formed in each of the through holes, and each of the LCD conductive pads electrically connects to the TFT array lead via the ITO film of one of the through holes.

5. A manufacturing method of a liquid crystal display panel with ultra-narrow bottom border, comprising the following steps:
cutting an entire produced substrate to form a plurality of LCD panel, each of the LCD panel comprising a TFT array substrate, a CF substrate disposed opposite to the TFT array substrate, and a liquid crystal layer disposed between the TFT array substrate and the CF substrate;
cutting the CF substrate of a bottom border area of each of the LCD panel to expose a pattern on a substrate of the TFT array substrate in the bottom border area;
forming an insulating layer on the substrate of the TFT array substrate exposed in the bottom border area, etching the insulating layer to form a plurality of LCD conductive pads configured to electrically connect a connection point of a driver chip, and on the insulating layer, wherein, each of the LCD conductive pads electrically connects to a TFT array lead formed by etching a bottom border area of the substrate of the TFT array substrate via one of a plurality of through holes.

6. The manufacturing method of a liquid crystal display panel with ultra-narrow bottom border according to claim 5, wherein the insulating layer is a photoresist layer or an organic insulating layer.

7. The manufacturing method of a liquid crystal display panel with ultra-narrow bottom border according to claim 5, further comprising:
forming an ITO film in each of the through holes, wherein a first LCD conductive pad of an upper side of the insulating layer electrically connects to the TFT array lead via the ITO film of one of the through holes.

8. The manufacturing method of a liquid crystal display panel with ultra-narrow bottom border according to claim 6, further comprising:
forming an ITO film in each of the through holes, wherein a first LCD conductive pad of an upper side of the insulating layer electrically connects to the TFT array lead via the ITO film of one of the through holes.
